(19) United States
(12) Patent Application Publication
(10) Pub. No.: US 2008/0271128 A1
(43) Pub. Date: Oct. 30, 2008

(54) Method and System for Retaining and Protecting Sensitive User-Related Information

(75) Inventor: Christoph Hermann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,130

(22) PCT Filed: Oct. 23, 2006
(86) PCT No.: PCT/IB2006/053888

§ 371 Date: Apr. 22, 2008

Related U.S. Application Data
(60) Provisional application No. 60/730,115, filed on Oct. 25, 2005.

(51) Int. Cl. G06F 21/00

(52) U.S. Cl. 726/7

(57) ABSTRACT

A method, device and system for managing and altering a plurality of sensitive information are disclosed. The device comprises a memory for storing the sensitive information, an interface device for enabling communication between the memory and an external device, and a timer for providing a time-based value associated with the storing of each of the sensitive information. The device may communicate with a processor-based system that includes an input device via a wired or wireless communication media. The processor-based system receives selected sensitive information from the device and may provide altered sensitive information to the device.

The invention is related to the field of security and more specifically, a method and system for retaining and protecting sensitive user-related information.

The user of a personal computer, mobile telephone or other similar devices typically needs one or more passwords or entry codes in order to gain access to a software application, e.g., a mail program. The increasing number of devices, websites or application programs to which a user requires the entry of a password or other sensitive information places a burden on the user to manage all the many different passwords, entry codes or other sensitive information.

It is obvious that for keeping a necessary security level, it will soon become too much for the user to keep track of all different passwords as well as remembering to which application, device or website the passwords or entry codes belong. This burden is compounded if the passwords are changed on a timely-basis. For security reasons, passwords are changed at regular time intervals in order to reduce the risk that the password is discovered. Such time-based changes may be imposed on the user by a system administrator, for example.

A simple method to overcome the burden of remembering passwords is to use the same password for all applications, devices or websites. However, in this case, the disclosure of the password compromises all applications, devices and websites using the password.

In another method the user may incorporate an encryption program, e.g., pretty-good-privacy (PGP), to create a password-protected text-file that contains all the user's passwords. In this way only one password is needed to provide access to the password protected file. However, the user must still take time to change the passwords stored in the file when required to change passwords or access codes and is required to have the password-protected file and the associated encrypting software available.

Portable management devices are well-known in the art. For example, US Published Patent Application 2004/0193925, published Sep. 30, 2004, discloses a portable management device that can be connected to a computer and operates without having to pre-configure or install a software application on the computer or on the destination system. US Published Patent Application 2004/0158746, published Aug. 12, 2004, discloses an automatic log-in processing and password management system for multiple target web sites. However, these devices require that the user manually alter passwords on a timely basis to increase the security of the passwords.

Hence, there is a need for managing different passwords while relieving a user from the burden of memorizing all the passwords and for managing the passwords on a timely basis.

A method, device, and system for managing and altering a plurality of sensitive information are disclosed. The device comprises a memory for storing the sensitive information, an interface device for enabling communication between the memory and an external device, and a timer for providing a time-based value associated with the storing of sensitive information. The device may communicate with a processor-based system that includes an input device via a wired or wireless communication media. The processor-based system receives selected sensitive information from the device and may provide altered sensitive information to the device.

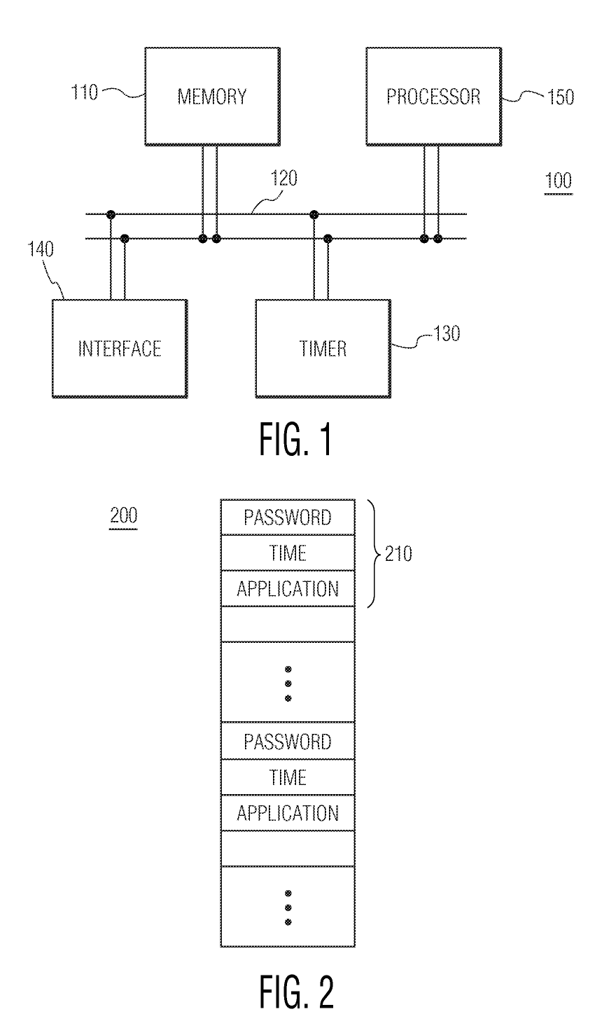

FIG. 1 illustrates a block drawing of an exemplary portable management device in accordance with the principles of the invention;

FIG. 2 illustrates an exemplary data structure for managing passwords in a portable management device in accordance with the principles of the invention;

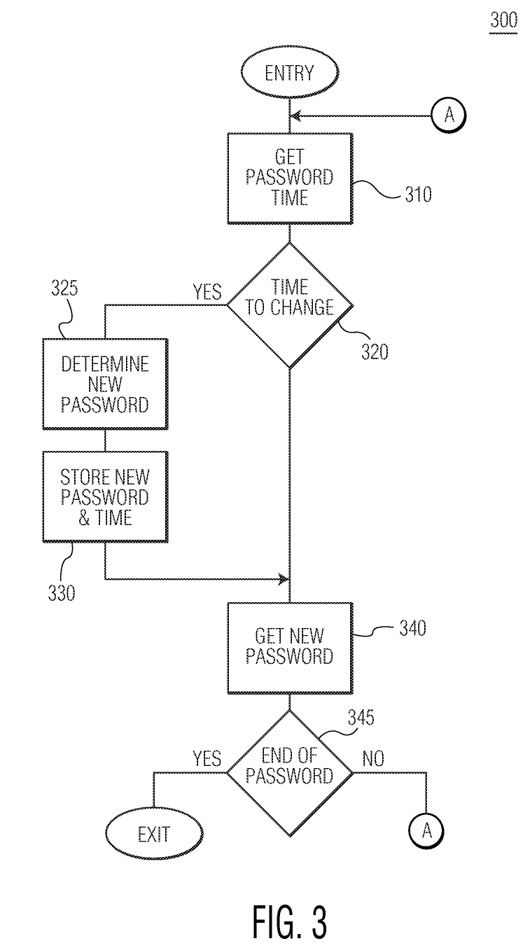

FIG. 3 illustrates a flow chart of an exemplary process in accordance with the principles of the invention; and

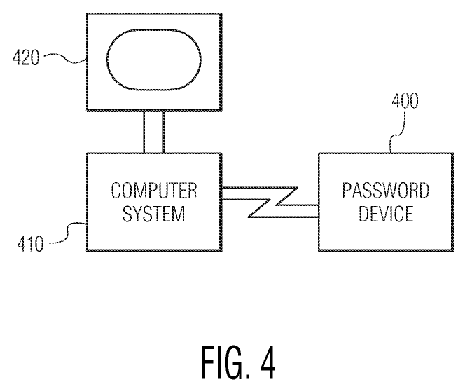

FIG. 4 illustrates an exemplary system using a password device in accordance with the principles of the invention.

It is to be understood that these drawings are for purposes of illustrating the concepts of the invention and are not to scale. It will be appreciated that the same reference numerals, possibly supplemented with reference characters where appropriate, have been used throughout to identify corresponding parts.

FIG. 1 illustrates a block diagram of an exemplary embodiment of a portable management device 100 in accordance with the principles of the invention. In this exemplary embodiment, a memory 110 is connected to a communication bus 120. Bus 120 provides communications between memory 110 and interface 140. Memory 110 is preferably a non-violate memory that is used to store sensitive information, i.e., passwords, access codes, etc. Although memory 110 is discusses with regard to non-violate memory, it would be recognized by those skilled in the art that memory 110 may be a violate memory, e.g., RAM, with an appropriate battery backup system (not shown) or a portable disk drive (magnetic or optical) or other similar portable storage device.

Interface 140 allows two-way communication between the internal components of device 100 and an external environment. Interface 140 may be selected from well-known interfaces. For example, interface 140, is preferable, a USB (Universal Serial Bus) interface. However, it would be recognized that the interface may be a serial, or a parallel interface using a wired or wireless (RF or optical) connection. For example, interface 140 may operate wirelessly using a BLUETOOTH communication protocol.

Also, shown is timer 130 in communication with bus 120. Timer 130 provides a means for establishing a time value which is used in determining the expiration time of one or more passwords, as is more fully described with regard to FIG. 3.

Also, shown is optional processor 150 in communication with memory 110 and timer 130 via bus 120. Processor 150 includes code that, in one aspect of the invention, is operable to alter the contents of memory 110 as is more fully described herein.

FIG. 2 illustrates an exemplary data structure 200 contained in memory 110 for storing data regarding the sensitive information to be managed and maintained. In this exemplary data structure, a password, associated time and application name are stored in a memory section represented as block 210. The associated time may be an absolute time or a relative time, e.g., a countdown. The application field represents the name or identification of application to which the password or entry code is associated.

FIG. 3 illustrates a flow chart of an exemplary process 300 for changing passwords in accordance with the principles of the invention. In this exemplary process, a time associated with a password is obtained at block 310. At block 320 a determination is made whether a known criterion has been satisfied. If the answer is in the affirmative, a new password is obtained at block 325 and the new password and current time are stored in the memory at block 330. At block 340, the next password in the memory is obtained and at block 345 a determination is made whether the end of the stored passwords has been reached. If the answer is in the affirmative, then processing is concluded. Otherwise, processing continues at block 310 to determine whether the obtained password should be changed.

It would be appreciated that in the determination shown at block 320, the password time may be compared to a current time that may be generated locally, i.e., within the password device 100, or obtained from an external source. In one aspect, a locally generated time may be a relative countdown (or count-up) time, which when the criterion is satisfied, i.e., the countdown time expiring or count-up time reaching a predetermined value, indicates that the associated password is to be changed. In another aspect, the time stored may be an absolute time (365 day/24 hour clock). In this case, the criterion may be selected as the elapse of a predetermined time interval. After the predetermined time has elapsed, the associated password is changed. The absolute time, as discussed, may be obtained from a locally generated time clock or provided by an external source. In one aspect of the invention, the predetermined time interval may be set independently for each application.

At block 325, a new password may be obtained automatically by one or more processes performed locally, i.e., within device 100, or may be provided by an external source. In the former case, the password may be changed based on a dynamically changing password scheme. In this case, the stored password provides all or part of the password code that allows entry to the associated program or application. In the latter case, a control software may prompt the user to provide a new password. For example, a user may be prompted to input a new password and provide a verification of the new password by reentering it. The verified new password and associated time may then be stored in accordance with the principles of the invention.

FIG. 4 illustrates an exemplary system wherein password device 100 is in communicate with a computer system 410 including monitor 420. Password device 100 may communication with computer system 410 via a wired communication link, e.g., serial, parallel, USB, or a wireless communication link, e.g., Rf, infrared, optical, magnetic induction. In one embodiment, the device may be similar to a USB connected memory stick which receives power when connected to the computer system 410. In other aspects, power may be provided locally using well-known battery or power source technology. Although a computer system is shown, it would be recognized that the computer system 410 may also include devices, such as a PDA or cellular telephone that may be connected to device 100 to provide access to the stored passwords or receive application specific passwords.

In one aspect of the invention, the control software, described previously, may be loaded within the memory of device 100 and downloaded onto a desktop or laptop computer (i.e., computer system 410). The software controlling the processing shown in FIG. 3 may be executed from the computer system 410, wherein instructions may be displayed on the computer system display screen and new password information provided via an associated keyboard or similar entry device, i.e., handwriting recognition software. In another aspect of the invention, the control software may be pre-loaded on computer system 410 which, when device 100 is connected to computer system 410, is activated to execute the processing shown in FIG. 3. The processing may be performed either locally on device 100 or on computer system 410. When processing shown in FIG. 3 is executed on computer system 410, coordination and synchronization between the local device timer and the compute system timer is performed. Such coordination and synchronization is well-known in the art and need not be discussed in detail herein. It would be recognized that the control software referred to may represent or include an application program that performs a designated operation or a graphic user interface (GUI) that enables a user to communicate with the password container and/or gain access to the secure information stored in the password container.

As device 100 will contain a significant amount of highly confidential information, in another aspect of the invention, it may be necessary to protect the information contained in device 100 by means of a password. In this case, when password-protected device 100 is connected to computer system 410, for example, an access application may be executed which allows a user to enter a password, via a keyboard device, that enables access to the application specific passwords. The use of a password to enable access to the application specific passwords is advantageous as it prevents access from a second device or application program that prompts device 100 to reveal the stored information.

The password container may contain a large number of highly confidential information, e.g., passwords, bank account codes, financial records, etc., that may be necessary to protect the information stored by a password. Hence, it would be advantageous that an external device or application program is prevented from initiating communication with device 100. In this case the only initiation of communication with the device 100 is from this device 100 and not from another application program or device. This may be further explained by means of an example: If the user wants to open a password protected document, the password of which is available in the password container device, the user will open the document using his word-processor program, and the word-processor program will prompt him to enter the password. It may increase security, if it is avoided that the word-processing program is configured, such that it directly contacts the password processor in order to obtain the password. Such configuration information must be stored somewhere and could be intercepted by an intruder (e.g. by running a Trojan horse virus) to contact the password container program. Thus, the user would be instructed to always, via his local machine, access the password container to connect to the word processor program, i.e. the initiation of the interaction originates from the password container device. For this, the word processor program may need an additional interface to perform such interaction.

In addition, to increase security the device 100 (i.e. the password container) may be provisioned with means for authentication, i.e. it will only communicate with devices or application programs, which can be authenticated successfully. This may be done for example, by signatures. This does not impose additional burden to the user. In any case, if the user wants to protect a document written with a special word processing program, for example, the user has to tell the word processing program that he intends to protect the document by means of a password. Within this step, the word processing program (or even only the particular “instance” of the word processing program on the machine, which the user uses) may be introduced to the password container as a “trusted” application program, and an agreed-upon signature for this application program may be stored on the password container. Next time the document is to be accessed, the password container will first check the authenticity of the application program and then provide the document password for the particular document. It may be necessary to forbid changing the name of such documents without interacting with the password container. Otherwise the password container may lose the “handle” or reference to this document, if its name changes. Note that moving the document into a different folder will not cause trouble. In order to open the document, it is necessary for the user to know the exact directory path, under which the document is stored.

In still another aspect, a known sequence of commands and responses may be required to enable software access to information stored in memory 110 in device 100. In this case, a device 100 may download a communication software or application or GUI module into the computer system 410 that enables a user to provide a limited response to a known request made by device 100. Device 100 may, in response to a valid (expected) limited response may download one or more similar communication modules that enable a user to provide additional limited responses to requests made by device 100. The detection of any incorrect response may cause device 100 to prevent any further access to the memory contained therein. This denial of access may be for a limited time. This operation of a sequence of requests and limited responses is advantageous over a simple password as it requires an interactive and more sophisticated communication protocol with device 100. In one aspect, even if an incorrect limited response is detected, device 100 may continue the interactive sequence of requests and responses for an extended period of time, even though access to the data is denied. In this case, an intruder would not know at which step in the sequence access was denied. Hence, the secure data is protected from repeated attempts to determine the limited responses.

It would be appreciated that in one aspect, an application manufacturer may provide supplemental information to interact with device 100. For example, an Internet browser when accessing a financial or bank web site in which personal data, e.g., account number, user identification code, etc., may contain a supplemental software package (“plug-in”) that is allowed (after authentication) to access and read the information in device 100 associated with the financial or bank web site. Hence, a bank web site may prompt the user to input a password or access code to access device 100 and the web site software reads the appropriate secure data from device 100.

Although the present invention has been discussed with regard to a device similar to a USB memory stick, it would be appreciated that the form and protocol may be compatible with PCMCIA or may include violate Random Access Memory (RAM) with battery-backup.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention.

It is expressly intended that all combinations of those elements that perform substantially the same function in substantially the same way to achieve the same results are within the scope of the invention. Substitutions of elements from one described embodiment to another are also fully intended and contemplated.

1. A device for managing and altering a plurality of sensitive information comprising:
a memory for storing the sensitive information;
an interface device for enabling communication between the memory and an external device; and
a timer for providing a time-based value associated with the storing of each of the sensitive information.

2. The device as recited in claim 1, further comprising:
a processor for executing the step of:
altering the sensitive information when a criterion is satisfied.

3. The device as recited in claim 1, wherein each of the sensitive information is associated with a password word, an entry code or an access code.

4. The device as recited in claim 1, wherein the time-based value is represented as an absolute time.

5. The device as recited in claim 1, wherein the time-based value is represented as a relative time.

6. The device as recited in claim 1, wherein the interface device is operable for executing communication protocols selected from the group consisting of: serial, parallel, USB, Bluetooth, IEEE 802.11.

7. The device as recited in claim 1, wherein the interface device is operable for communicating over a medium selected from the group consisting of: wireless or wired.

8. The device as recited in claim 1, wherein the wireless medium consisting of: Rf, optical, and infrared.

9. The device as recited in claim 1, further comprising:
a source for providing power to the memory and the timer.

10. The device as recited in claim 1, wherein power is provided by the external source.

11. The device as recited in claim 1, wherein the sensitive information is received from the external source.

12. The device as recited in claim 1, wherein the sensitive information is locally generated.

13. The device as recited in claim 1, further comprising:
means for preventing access to the stored sensitive information.

14. A method for storing and altering a plurality of sensitive information comprising the steps of:
storing each of the plurality of sensitive information and associated time-based value in a memory; and
enabling alteration of the sensitive information when a time-based criterion is satisfied.

15. The method as recited in claim 14, wherein the time-based value is selected from the group consisting of an absolute time, a countdown relative time and a count-up relative time.

16. The method as recited in claim 14, wherein the criterion is selected from the group consisting of: a determined time interval, expiration of a countdown time, and achieving a count-up time.

17. The method as recited in claim 14, wherein the step of enabling altering the sensitive information further comprises the steps of:
receiving a first and second altered sensitive information;
storing the altered sensitive information when the received first and second sensitive information are the same; and
storing a new associated time-based value.

18. The method as recited in claim 17, wherein the first and second altered sensitive information is received from an external source.

19. The method as recited in claim 18, wherein the step of enable altering the sensitive information further comprises the steps of:
generating an altered sensitive information; and
storing the altered sensitive information and a new associated time-based value.

20. A system for managing and altering a plurality of sensitive information the system comprising:
an external device comprising:
an input device for inputting sensitive information; and
a portable device comprising:
a memory for storing the sensitive information;
an interface device for enabling communication between the memory and the external device; and
a timer for providing a time-based value associated with the storing of each the sensitive information, wherein the external device provides the sensitive information to the portable device and the portable device provides selective sensitive information to the external device.

21. The system as recited in claim 20, wherein power is provided to the portable device by the external device.

22. The system as recited in claim 20, wherein the portable device further comprising:
a source for providing power to the memory.

23. The system as recited in claim 20, wherein the portable device further comprising:
a processor for altering the sensitive information when a criterion is satisfied.

24. The system as recited in claim 20, wherein the interface device is operable for executing communication protocols selected from the group consisting of: serial, parallel, USB, Bluetooth, IEEE 802.11.

25. The system as recited in claim 20, wherein the interface device is operable for communicating over a medium selected from the group consisting of: wireless or wired.

26. The system as recited in claim 25, wherein the wireless medium consisting of: Rf, optical, and infrared.

27. The device as recited in claim 13, wherein the access preventing means is a password.

28. The device as recited in claim 13, wherein the access preventing means comprises an interactive exchange of requests and limited responses.

29. The method as recited in claim 19, further comprising the step of:
preventing access to the stored sensitive information.

30. The method as recited in claim 29, wherein preventing access to the stored sensitive information is via a value selected from the group consisting of a password and a signature.

31. The method as recited in claim 29, wherein preventing access to the stored sensitive information is via an interactive exchange of requests and limited responses.

32. The system as recited in claim 20, wherein the sensitive information is access protected from the external device.

33. The system as recited in claim 32, wherein access to the sensitive information is enabled by providing a value selected from the group consisting of a password and a signature.

34. The system as recited in claim 32, wherein access to the sensitive information is enabled by successfully completing an interactive exchange of requests and limited responses.

35. The system as recited in claim 20, wherein the external device includes control software that is pre-loaded.

36. The system as recited in claim 20, wherein the external device includes control software that is downloaded from the portable device.
